(19) United States
(12) Patent Application Publication
(10) Pub. No.: US 2014/0135223 A1
(43) Pub. Date: May 15, 2014

(54) METHOD FOR JOINING SUPERCONDUCTING WIRES, AND SUPERCONDUCTING JOINT

(71) Applicants: Mark BLUMENTHAL, Oxfordshire (GB); M'Hamed LAKRIMI, Oxfordshire (GB)

(72) Inventors: Mark BLUMENTHAL, Oxfordshire (GB); M'Hamed LAKRIMI, Oxfordshire (GB)

(21) Appl. No.: 13/874,689

(22) Filed: May 1, 2013

(30) Foreign Application Priority Data
May 2, 2012 (GB) 1207624.6
May 21, 2012 (GB) 1208949.6

(51) Int. Cl. H01F 41/04; H01F 6/06

(52) U.S. Cl. CPC H01F 41/048; H01F 6/06
USPC 505/211; 505/400; 29/599; 174/125.1

(57) ABSTRACT

The method comprises stripping matrix material from superconducting wires to expose superconducting filaments, placing the filaments between electrically conductive pieces, and applying magnetic welding to the electrically conductive pieces. The resulting superconducting joint comprises the filaments cold welded with molecular bonds between each other and between the filaments and the two electrically conductive pieces.

### BACKGROUND OF THE INVENTION

1. Field of the Invention

The present invention addresses the issue of joining superconducting wires in such a manner to produce a superconducting joint. The present invention aims to provide such a method which is effective, produces mechanically robust joints quickly, and avoids or reduces the use of dangerous or harmful chemicals.

2. Description of the Prior Art

An application for superconducting wire is in producing superconducting electromagnets for generating strong magnetic field for magnetic resonance imaging (MRI). Several coils are required, each made up of several kilometers of wire. It is necessary to join these coils together in an electrical circuit, and it is commonly required to make joints within the length of wire used for any particular coil. The joints usually take the form of joint cups filled with a superconducting alloy in which exposed superconducting filaments are immersed. The resultant joints are mechanically attached to the structure of the magnet as required. The present invention relates to the structure of such joints.

An example of a conventional superconducting wire comprises a number of NbTi filaments within a copper matrix material. A conventional method of joining such wires proceeds as follows.

The ends of the wires are etched in nitric acid to remove the copper matrix material, and then further etched in hydrofluoric acid to remove any oxide from the surfaces of the NbTi filaments. It is also well known to those skilled in the art that it is possible to remove the copper matrix and oxide using an electrolytic process. The filaments of the wires to be joined are twisted or plaited together to provide an area of contact between the filaments. The plaited or twisted filaments are immersed in a small cup of molten superconducting alloy such as PbBiSn or Wood's metal. While this method has been successfully employed for some time, safety and regulatory concerns mean that it is desired to phase out the use of lead, as used in PbBiSn and Wood's metal, and hydrofluoric acid.

The present invention accordingly aims to provide a method for electrically joining superconducting wires to produce superconducting joints in a manner which does not require the use of lead or lead alloys, of hydrofluoric acid. Such method should be rapid and produce electrically and mechanically reliable joints.

It is believed to be impossible to use conventional welding to join superconducting NbTi filaments together into a superconducting joint, as the required rise in temperature of the filaments would alter the molecular structure of the NbTi and ruin its superconducting properties.

The NbTi filaments themselves may be found too resistive to hold significant eddy currents, and so the process will be slightly inefficient or one would have to rely on very high powers from the capacitor banks which drive the magnetic coils.

Magnetic welding is a known method of welding electrically conductive components together without heat. Similar or dissimilar materials may be welded. Essentially, the technique relies on an oscillating magnetic field generating eddy currents which interact to cause the extreme acceleration of one piece towards another. On impact, usually at closing speeds of hundreds of meters per second, any surface oxide is broken away, and airflow caused by the relative motion of the pieces blows oxide away from the contact area. The resulting high-energy impact between clean metallic surfaces results in a cold weld—or molecular bond—between the materials of the pieces.

The prior art document available at the filing date of the present invention at www.english.pstproducts.com/index_htm_files/empt%20forming%20welding%20crim ping%20and%20cutting.pdf provides a background explanation of mechanical welding and mechanical crimping. A copy of that document is filed with the priority application GB1207624.6.

A known method of forming superconducting joints by pressure welding is described in US2011/0028327, but that method does not benefit from some of the advantages of the present invention: for example, the present invention provides for removal of oxides from surfaces to be welded, which is not the case for this prior art method. The present invention also provides a method in which the opportunity for movement of the filaments is reduced as compared to that in US2011/0028327, encouraging more filaments to be welded in the method of the present invention.

Other known methods, such as described in U.S. Pat. No. 5,082,164 and U.S. Pat. No. 5,111,574 involve the use of heat, which may be detrimental to the superconducting properties of the filaments.

### SUMMARY OF THE INVENTION

The present invention accordingly provides methods of joining superconducting filaments together to form superconducting wires without the use of lead, or hydrofluoric acid, and without the application of heat.

The above object is achieved in accordance with the present invention by a method for electrically joining superconducting wires wherein matrix material is stripped from superconducting wires to expose superconducting filaments of the superconducting wires, and the filaments are placed between two electrically conductive pieces, wherein one of the electrically conductive pieces is an electrically conductive tube or cup that is open at at least one end, and the other of the electrically conductive pieces is an insert that fits into the at least one open end of the tube or cup. The electrically conductive pieces are magnetically welded to form a superconducting joint that includes the filaments that are cold welded with molecular bonds between each other, and between the filaments and the two electrically conductive pieces. The magnetic welding takes place with the tube or cup being violently compressed onto insert 14, with the filaments positioned between the insert and the tube or cup.

The invention also encompasses a superconducting joint made according to the above-described method.

### BRIEF DESCRIPTION OF THE DRAWINGS

FIGS. 1A-1C illustrate steps in a method of the present invention, and a superconducting joint according to the present invention.

FIGS. 2A-2C illustrate steps in a method of the present invention, and a superconducting joint according to the present invention.

FIGS. 3A-3C illustrate steps in a method of the present invention, and a superconducting joint according to the present invention.

FIGS. 4A-4C illustrate steps in a method of the present invention, and a superconducting joint according to the present invention.

FIG. 5 illustrates a joint of the present invention protectively embedded in a filler material within a joint cup.

### DESCRIPTION OF THE PREFERRED EMBODIMENTS

The present invention employs the technique of magnetic welding for the production of superconducting joints between superconducting filaments.

Although NbTi filaments themselves are not ideally suitable as a participant in magnetic welding because the eddy current is dependent on the resistivity of the material and NbTi has a relatively high resistivity, the present invention provides a method of producing electrically and mechanically effective superconducting joints using magnetic welding.

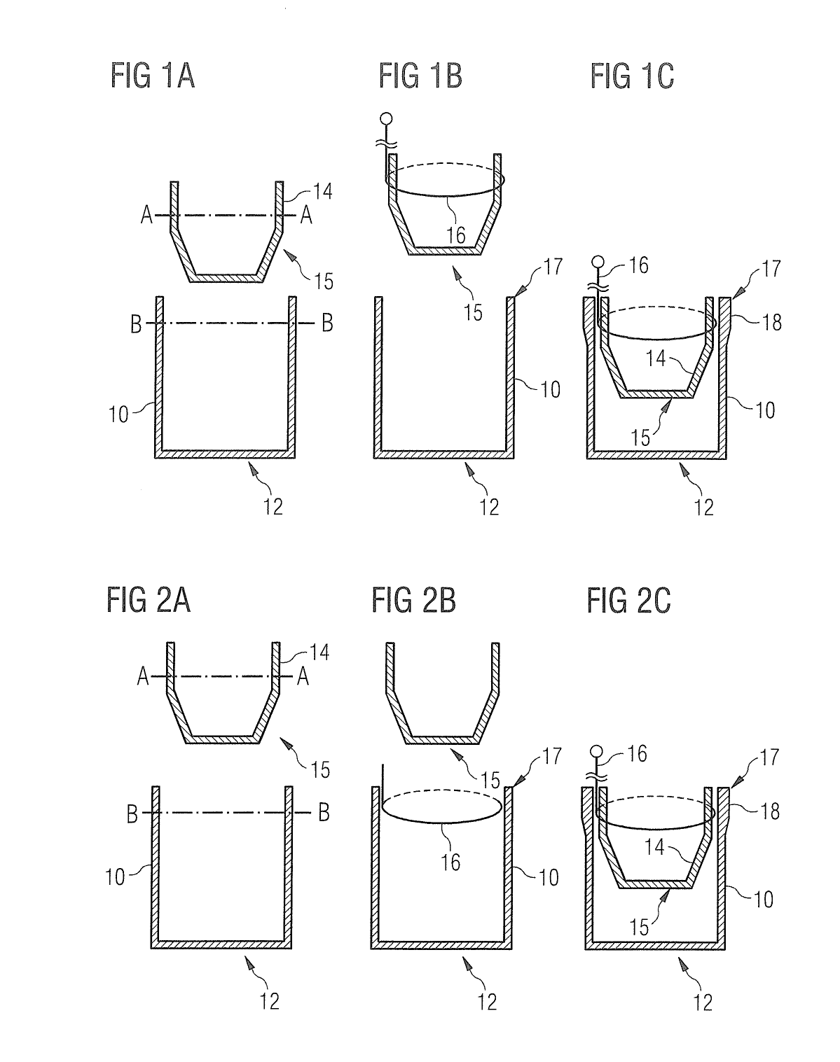

FIGS. 1A-1C illustrate a cross-section of components employed in steps of a method of the present invention.

As shown in FIG. 1A, an electrically conductive tube or cup 10 is provided. It may be open-ended, or closed at one end 12. An electrically conductive insert 14 is also provided. This insert preferably has a tapered end 15, which is preferably closed. The insert preferably has an outer cross-section at plane A-A which is the same shape as, but slightly smaller than an inner cross-section of the tube or cup 10 at plane B-B. The cross-sections are preferably circular.

In preparation for jointing, the matrix material, typically copper, of the wires to be joined, is stripped from ends of the wires to be joined, leaving exposed superconducting filaments for joining.

As shown in FIG. 1B, in this embodiment of the invention, filaments 16 of at least two superconducting wires to be joined are twisted or plaited together and wrapped around the insert 14. Plaiting of the filaments is preferred, as that ensures a greater surface area of the filaments being in contact with each other, and provides more reliable pattern of contact points between filaments. The outer dimension of the filaments 16 may be slightly larger than the inner dimension of the tube or cup 10 at plane B-B. A retaining feature may be incorporated into the shape of insert 14. The tapered end 15 of insert 14 is inserted into an open end 17 of tube or cup 10, to a sufficient distance that filaments 16 are trapped between insert 14 and tube or cup 10. A magnetic welding step is then applied, as is conventional in itself, other than for the presence of filaments 16. Tube or cup 10 is violently compressed onto insert 14, and moulds itself to the contours of the insert 14. The impact caused by the magnetic welding step cleans oxides from the surfaces of the filaments 16, the insert 14 and tube or cup 10. The pressure exerted due to the magnetic welding step causes a solid-state cold weld between the tube or cup 10 and the insert 14. Similarly, the impact also cleans oxides from the NbTi filaments 16, and the pressure drives the filaments together to form a solid state cold weld between filaments, and also between the filaments and the insert 14 and the tube or cup 10.

FIG. 1C schematically illustrates the resultant structure, wherein tube or cup 10 is magnetically welded by compression onto insert 14 and filaments 16. A bulge 18 may be visible on the outer surface of the tube or cup 10, where the tube or cup 10 has been forced onto the insert 14 and filaments 16.

A similar but alternative method is shown in FIGS. 2A-2C. In this method, the step of FIG. 2A corresponds in all respects with the step of FIG. 1A. However, as shown in FIG. 2B, instead of wrapping filaments 16 around the insert, the filaments are formed into a loop which is placed within the tube or cup 10. The insert 14 is then inserted into tube or cup 10 such that filaments 16 are trapped between tube or cup 10 and insert 14. In the magnetic welding step, the tube or cup 10 is violently compressed onto insert 14 and the loop of filaments 16. As described above, the impact of the tube or cup 10 meeting the insert 14 and filaments 16 at a speed of several hundred meters per second dislodges all surface oxides from the surfaces of the insert 14, tube or cup 10 and filaments 16. This, in conjunction with the pressure exerted on the surfaces of the insert 14, the tube or cup 10 and the filaments 16, causes a cold, solid state weld between the filaments 16, and between the filaments and the cup or tube 10, and the insert 14. A bulge 18 may again be visible on the outer surface of the tube or cup 10, as the tube or cup 10 is forced onto the insert 14 and the loop of filaments 16.

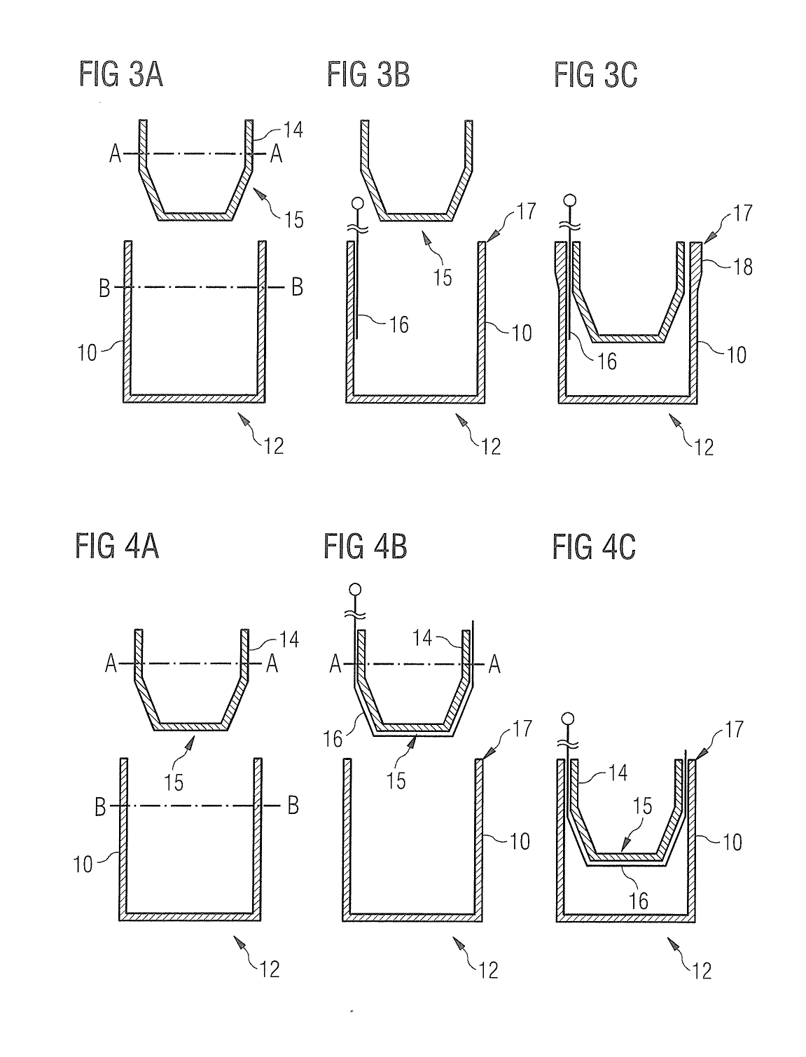

FIGS. 3A-3B show an alternative method and resulting structure. In this method, the step of FIG. 3A corresponds in all respects with the step of FIG. 1A. However, ends of filaments 16 are simply placed within the tube or cup 10 rather than being formed into a loop, as shown in FIG. 3B. FIG. 3C illustrates the magnetic welding step, in which the tube or cup 10 is violently compressed onto insert 14, and traps the filaments 16 between an outer surface of the insert 14 and an inner surface of the tube or cup 10. As described above, the impact of the tube or cup 10 meeting the insert 14 at a speed of several hundred meters per second dislodges all surface oxides from contacting surfaces of the filaments 16, the insert 14 and the tube or cup 10. This, in conjunction with the pressure exerted on the surfaces of the insert 14, the tube or cup 10 and the filaments 16, causes a solid state cold weld between the filaments 16, and between the filaments 16 and the cup or tube 10, and the insert 14. A bulge 18 may again be visible on the outer surface of the tube or cup 10, where the tube or cup 10 has been forced into impact with the insert 14 and filaments 16.

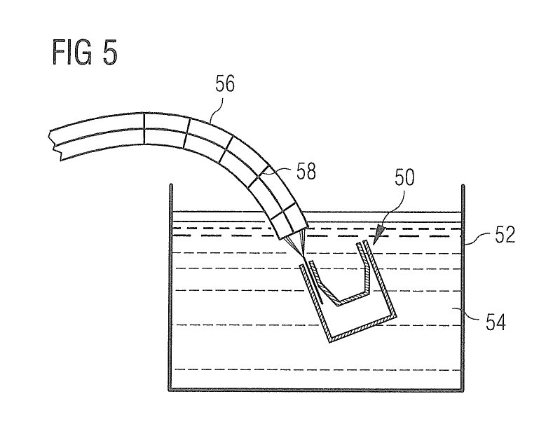

FIGS. 4A-4C show another alternative method and resulting structure. In this method, the step of FIG. 4A corresponds in all respects with the step of FIG. 1A. However, in this embodiment, the exposed ends of filaments 16 are wrapped over the tapered end 15 of the insert 14 prior to the magnetic welding step. FIG. 4C illustrates the result of the magnetic welding step, in which the tube or cup 10 is violently compressed into contact with insert 14, and traps the filaments 16 between an outer surface of the insert and an inner surface of the tube or cup 10. As described above, the impact of the tube or cup 10 meeting insert 14 and filaments 16 at a speed of several hundred meters per second dislodges all surface oxides from contacting surfaces of the filaments 16, the insert 14 and the tube or cup 10. This, in conjunction with the pressure exerted on the surfaces of the insert 14, the tube or cup 10 and the filaments 16, causes a solid state cold weld between the filaments 16, and between the filaments 16 and the cup or tube 10, and the insert 14. A bulge 18 may again be visible on the outer surface of the tube or cup 10, where the tube or cup 10 has been forced into contact with the insert 14 and filaments 16.

Magnetic welding is believed to work best with highly-conductive pieces to be joined. For that reason, copper or aluminum pieces are preferred. However, other materials such as stainless steel may be used, and the magnetically-welded parts may be of dissimilar materials, such as a copper piece and an aluminum piece.

In its general scope, the present invention provides a method for joining superconducting wires which involves stripping matrix material from superconducting filaments, placing these filaments between electrically conductive pieces and applying magnetic welding to those pieces, so that the filaments become cold welded with molecular bonds between each other and between the filaments and the two electrically conductive pieces.

The joint produced by the methods described thus far is as shown in FIGS. 1C, 2C, 3C, 4C. Two electrically conductive pieces—here, the insert 14 and the tube of cup 10—are magnetically welded together with superconducting filaments trapped between them. The superconducting filaments are themselves cold welded to each other and to the two electrically conductive pieces. As the superconducting filaments are themselves cold welded together, the joint is superconducting as electrical current can pass directly from one superconducting filament to another without passing through any other material.

Further steps may be applied as required by the application. FIG. 5 shows a joint 50 according to the invention, as illustrated in FIG. 3C, placed in a joint cup 52 and embedded in a filler material 54. Such joint cups are conventionally made of brass, but in joints of the present invention, they may be of plastic where they do not need to have any particular thermal or electrical properties. The filler material serves to mechanically protect the joint, and need not have any particular thermal or mechanical properties. Grease, wax or thermosetting plastic, or a resin may be used. Wires 56 may be bound 58, for example with cable ties, lacing or wire, to hold them together to avoid placing strain in the joint itself. Joint cup 52 may then be mounted within equipment as any conventional superconducting joint using a joint cup. Similar to known joint cups, any excess length of wires 56 may be coiled into the joint cup and held in place with the filler material 54. In use, the joint will be cooled to below the transition temperature of the superconducting wires.

It may be preferred to use a tube 10 which is open at both ends to avoid entrapment of air within the joint, which might later contaminate the interior of a vacuum vessel or cryogen vessel.

In alternative arrangements, any excess wire may be radially placed on the outer surface of coils, or in a groove cut into a former between coils, while the joint of the present invention is placed in a cup or trough filled with a wax, or a grease or a resin.

While the invention has been described with reference to NbTi filaments in the superconducting wires, it may also be applied to superconducting wires having Nb₃Sn filaments and MgB₂ or any other low and high temperature superconducting material for those skilled in the art. These superconductors could be in the form of wires or tapes without any restriction on cross-section.

While the particularly-described embodiments involve superconducting wires with multiple superconducting filaments, it may also be applied to superconducting wires which have a single superconducting filament, or “tapes” which are flat wires.

In the above-mentioned embodiments, the insert 14 may be made of a superconducting material, such as NbTi. This will increase the superconducting cross-section of the resulting joint, as any welds between filaments and the insert will from part of the superconducting joint, rather than only the welds between filaments.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for electrically joining superconducting wires, comprising:
stripping matrix material from superconducting wires to expose superconducting filaments of the superconducting wires;
placing the exposed superconducting filaments between two electrically conductive pieces, a first of said electrically conductive pieces being an electrically conductive tube or cup that is open at at least one end, and a second of the electrically conductive pieces being an insert that fits into said at least one open end; and
magnetically welding the two electrically conductive pieces to form a superconducting joint that comprises the exposed superconducting filaments welded with molecular bonds between each other and between the exposed superconducting filaments and the two electrically conductive pieces, whereby the tube or cup is violently compressed into contact with the insert with said exposed superconducting filaments positioned between the insert and the tube or cup.

2. A method as claimed in claim 1 comprising plaiting the exposed superconducting filaments together before placing the superconducting filaments between the two electrically conductive pieces.

3. A method as claimed in claim 1 wherein said insert has a tapered end and comprising, prior to said magnetic welding, wrapping the exposed superconducting filaments around said insert and inserting said tapered end of said insert into one open end of said tube or cup.

4. A method as claimed in claim 1 wherein said insert has a tapered end and comprising, prior to said magnetic welding, forming the exposed superconducting filaments into a loop and placing said loop within said tube or cup, and inserting said tapered end of said insert into one open end of said tube or cup.

5. A method as claimed in claim 1 wherein said insert has a tapered end and comprising, prior to said magnetic welding, placing the exposed superconducting filaments within said tube or cup, and inserting said tapered end of said insert into one open end of said tube or cup.

6. A method as claimed in claim 1 wherein said insert has a tapered end and comprising, prior to said magnetic welding, wrapping the exposed superconducting filaments over said tapered end of said insert, and inserting the tapered end of the insert, with said exposed superconducting filaments wrapped thereover, into one open end of said tube or cup.

7. A method as claimed in claim 1 comprising forming at least one of said electrically conducting pieces of material that is superconducting at an operating temperature of said superconducting joint.

8. A method as claimed in claim 1 comprising placing said superconducting joint in a joint cup, and embedding said superconducting joint in a filler material within said joint cup.

9. A method as claimed in claim 8 comprising binding the superconducting wires to hold said superconducting wires together to reduce strain in said superconducting joint.

10. A method as claimed in claim 1 comprising employing superconducting wires that each comprise multiple superconducting filaments.

11. A method as claimed in claim 1 comprising providing each of said superconducting wires with a superconducting tape.

12. A method as claimed in claim 1 comprising forming said electrically conductive pieces of respectively different materials.

13. A method for electrically joining superconducting wires, comprising:
stripping matrix material from superconducting wires to expose superconducting filaments;
placing the filaments between electrically conductive pieces; and
applying magnetic welding to the electrically conductive pieces, to form a superconducting joint comprising the filaments cold welded with molecular bonds between each other and between the filaments and the two electrically conductive pieces, wherein one of the electrically conductive pieces is an electrically conductive tube or cup, open at at least one end, and the other of the electrically conductive pieces is an insert, and wherein the step of magnetic welding violently compresses the tube or cup into contact with the insert and the filaments which are positioned between the insert and the tube or cup.

14. A method for joining superconducting wires according to claim 13, wherein the superconducting filaments are plaited together before they are placed between the electrically conductive pieces.

15. A method according to claim 13 wherein, prior to the magnetic welding step, the filaments are wrapped around the insert; and a tapered end of insert is inserted into an open end of tube or cup, in preparation for the magnetic welding step.

16. A method according to claim 13 wherein, prior to the magnetic welding step, the filaments are formed into a loop which is placed within the tube or cup; and
a tapered end of the insert is inserted into an open end of tube or cup, in preparation for the magnetic welding step.

17. A method according to claim 13 wherein, prior to the magnetic welding step, the filaments are placed within the tube or cup; and a tapered end of insert is inserted into an open end of tube or cup, in preparation for the magnetic welding step.

18. A method according to claim 13 wherein, prior to the magnetic welding step, the filaments are wrapped over a tapered end of the insert; and a tapered end of insert is inserted into an open end of tube or cup, in preparation for the magnetic welding step.

19. A method for joining superconducting wires according to claim 13, wherein one of the electrically conducting pieces is superconducting at the temperature of operation of the joint.

20. A method for joining superconducting wires according to claim 13, further comprising the step of:
placing the superconducting joint in a joint cup, and embedding superconducting joint in a filler material within the joint cup.

21. A method for joining superconducting wires according to claim 20, further comprising the step of binding the superconducting wires to hold them together to avoid placing strain in the superconducting joint itself.

22. A method for joining superconducting wires according to claim 13, wherein the superconducting wires each comprise multiple superconducting filaments.

23. A method for joining superconducting wires according to claim 13, wherein the superconducting wires comprise a superconducting tape.

24. A method for joining superconducting wires according to claim 13, wherein the electrically conductive pieces are of different materials.

25. A superconducting joint between superconducting wires, comprising:
filaments of the superconducting wires cold welded with molecular bonds between each other and between the filaments and two electrically conductive pieces as a result of magnetic welding between the two electrically conductive pieces, wherein one of the electrically conductive pieces is an electrically conductive tube or cup, open at least at one end, and the other of the electrically conductive pieces is an insert, and wherein the tube or cup has been compressed onto the insert with the filaments positioned between the insert and the tube or cup.

26. A superconducting joint according to claim 25, wherein the superconducting filaments are plaited together.

27. A superconducting joint according to claim 25 wherein the filaments are wrapped around the insert.

28. A superconducting joint according to claim 25 wherein the filaments are formed into a loop positioned between the tube or cup; and the insert.

29. A superconducting joint according to claim 25 wherein the filaments are wrapped over a tapered end of the insert.

30. A superconducting joint according to claim 25 wherein one of the electrically conducting pieces is superconducting at the temperature of operation of the joint.

31. A superconducting joint according to claim 25 wherein the superconducting joint is embedded in a filler material within a joint cup.

32. A superconducting joint according to claim 31 wherein the superconducting wires are bound to hold them together, thereby to avoid placing strain in the superconducting joint itself.

33. A superconducting joint according to claim 25, wherein the superconducting wires each comprise multiple superconducting filaments.

34. A superconducting joint according to claim 25, wherein the superconducting wires comprise a superconducting tape.

35. A superconducting joint according to claim 25, wherein the electrically conductive pieces are of different materials.
